(19) United States
(12) Patent Application Publication
(10) Pub. No.: US 2024/0430773 A1
(43) Pub. Date: Dec. 26, 2024

(54) PATH SWITCH FOR CONNECTED STATE MOBILITY

(71) Applicant: QUALCOMM Incorporated, San Diego, CA (US)

(72) Inventors: Punyaslok PURKAYASTHA, San Diego, CA (US); Ozcan OZTURK, San Diego, CA (US); Gavin Bernard HORN, La Jolla, CA (US); Miguel GRIOT, La Jolla, CA (US); Aziz GHOLMIEH, Del Mar, CA (US)

(21) Appl. No.: 18/338,932

(22) Filed: Jun. 21, 2023

(51) Int. Cl. H04W 36/38; H04W 36/02; H04W 40/24

(52) U.S. Cl. CPC H04W 36/38; H04W 36/02; H04W 40/248

(57) ABSTRACT

Aspects of this disclosure relate generally to mobility in a service-based architecture. Some aspects more specifically relate to path switching in a service-based architecture. In some examples, a distributed node may exchange signaling with a service server to configure and execute a path switch in connection with handover of a user equipment to the distributed node. For example, the distributed node may communicate with the service server directly. As another example, the distributed node may communicate with a mobility service to execute the path switch. In some examples, aspects described herein provide for a service server to buffer data and provide data forwarding in connection with the path switch.

### FIELD OF THE DISCLOSURE

Aspects of the present disclosure generally relate to wireless communication and to techniques and apparatuses for path switching for connected state mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A wireless communication network may implement a service-based architecture to provide access for user equipment (UEs) to services. A service-based architecture is one where functionalities of the system (such as security, mobility, and other examples described herein) are isolated and deployed as respective network entities (referred to as service servers). These services may have interfaces such as application programming interfaces (APIs). To interact with a given service, another service or application or network function may use the corresponding API. Distributed nodes, such as enhanced distributed units (eDUs) may provide radio access via cells. An eDU may handle base station physical (PHY) (and perhaps medium access control and/or radio link control) layer functionality. Thus, the eDU may implement the air interface. There are other functions which can be moved into the cloud, such as higher layer packet processing (e.g., packet data convergence protocol (PDCP) and mobility services). Generally, a service may implement functionalities of the central unit (CU) (in the radio access network (RAN)) and functionalities of the core network (such as user plane or control plane core network functionality), thus reducing complexity and interaction between core network entities and RAN entities. Thus, scalability and flexibility are improved using cloud deployment.

Handover is a procedure by which a UE (e.g., the context of a UE, which is used by the network to facilitate communications of the UE) is transferred from a source node to a target node. After handover is complete, the UE may communicate with the network via the target node instead of the source node. However, services of the network (such as a data routing service, a sensing service, a positioning service, and so on) may not be aware of the handover, and may operate according to a path between the services and the source node. A path switch may provide for the path to be updated so that these services are communicating with the target node after the handover. However, a path switch may be facilitated by a core network entity (such as an access and mobility management function) which may not be present in a service-based architecture.

Various aspects relate generally to mobility in a service-based architecture. Some aspects more specifically relate to path switching in a service-based architecture. In some examples, a distributed node (e.g., an eDU) may exchange signaling with a service server to configure and execute a path switch in connection with handover of a UE to the eDU. For example, the distributed node may communicate with the service server directly. As another example, the distributed node may communicate with a mobility service to execute the path switch. In some examples, aspects described herein provide for a service server to buffer data and provide data forwarding in connection with the path switch.

Particular aspects of the subject matter described in this disclosure can be implemented to realize one or more of the following potential advantages. In some examples, by communicating with the service server directly to execute the path switch, the described techniques can be used to configure and execute path switching without the involvement of a mobility service. In some examples, by communicating with the service server via the mobility service to execute the path switch, the described techniques can be used to reduce redundancy in signaling of information, to facilitate the path switch, that may already be known to the mobility service. In some examples, by buffering and data forwarding at the service server, and by stopping data transmission towards the source node based on receiving a handover indication from the source node, end marker packet transmission to the source node can be eliminated, thereby reducing overhead.

Some aspects described herein relate to a method of wireless communication performed by a distributed node. The method may include transmitting, in association with a service server, a path switch request message indicating to configure a path between the service server and the distributed node. The method may include receiving an acknowledgement of the path switch request message. The method may include communicating with the service server on the path.

Some aspects described herein relate to a method of wireless communication performed by a service server. The method may include receiving, in association with a distributed node, a path switch request message indicating to configure a path between the service server and the distributed node. The method may include transmitting an acknowledgement of the path switch request message. The method may include configuring the path to the distributed node.

Some aspects described herein relate to a distributed node for wireless communication. The distributed node may include one or more memories and one or more processors coupled to the one or more memories. The one or more processors may be individually or collectively configured to transmit, in association with a service server, a path switch request message indicating to configure a path between the service server and the distributed node. The one or more processors may be individually or collectively configured to receive an acknowledgement of the path switch request message. The one or more processors may be configured to communicate with the service server on the path.

Some aspects described herein relate to a service server for wireless communication. The service server may include one or more memories and one or more processors coupled to the one or more memories. The one or more processors may be individually or collectively configured to receive, in association with a distributed node, a path switch request message indicating to configure a path between the service server and the distributed node. The one or more processors may be individually or collectively configured to transmit an acknowledgement of the path switch request message. The one or more processors may be configured to configure the path to the distributed node.

Some aspects described herein relate to a non-transitory computer-readable medium that stores a set of instructions for wireless communication by a distributed node. The set of instructions, when executed by one or more processors of the distributed node, may cause the distributed node to transmit, in association with a service server, a path switch request message indicating to configure a path between the service server and the distributed node. The set of instructions, when executed by one or more processors of the distributed node, may cause the distributed node to receive an acknowledgement of the path switch request message. The set of instructions, when executed by one or more processors of the distributed node, may cause the distributed node to communicate with the service server on the path.

Some aspects described herein relate to a non-transitory computer-readable medium that stores a set of instructions for wireless communication by a service server. The set of instructions, when executed by one or more processors of the service server, may cause the service server to receive, in association with a distributed node, a path switch request message indicating to configure a path between the service server and the distributed node. The set of instructions, when executed by one or more processors of the service server, may cause the service server to transmit an acknowledgement of the path switch request message. The set of instructions, when executed by one or more processors of the service server, may cause the service server to configure the path to the distributed node.

Some aspects described herein relate to an apparatus for wireless communication. The apparatus may include means for transmitting, in association with a service server, a path switch request message indicating to configure a path between the service server and the apparatus. The apparatus may include means for receiving an acknowledgement of the path switch request message. The apparatus may include means for communicating with the service server on the path.

Some aspects described herein relate to an apparatus for wireless communication. The apparatus may include means for receiving, in association with a distributed node, a path switch request message indicating to configure a path between the apparatus and the distributed node. The apparatus may include means for transmitting an acknowledgement of the path switch request message. The apparatus may include means for configuring the path to the distributed node.

Aspects generally include a method, apparatus, system, computer program product, non-transitory computer-readable medium, user equipment, base station, wireless communication device, network entity, network node, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a service-based architecture, in accordance with the present disclosure.

FIG. 5 is a diagram illustrating an example of a protocol configuration for a service-based architecture, in accordance with the present disclosure.

FIG. 6 is a diagram illustrating an example of enhanced distributed unit (eDU) handover, in accordance with the present disclosure.

FIG. 7 is a diagram illustrating an example of a path switch from a source eDU to a target eDU, in accordance with the present disclosure.

FIG. 8 is a diagram illustrating an example of a path switch from a source eDU to a target eDU, in accordance with the present disclosure.

FIG. 9 is a diagram illustrating an example of a path switch from a source eDU to a target eDU, in accordance with the present disclosure.

FIG. 10 is a flowchart of an example method of wireless communication.

FIG. 11 is a flowchart of an example method of wireless communication.

FIG. 12 is a diagram of an example apparatus for wireless communication, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of a hardware implementation for an apparatus employing a processing system, in accordance with the present disclosure.

FIG. 16 is a diagram of example components of a device associated with path switch for connected state mobility.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

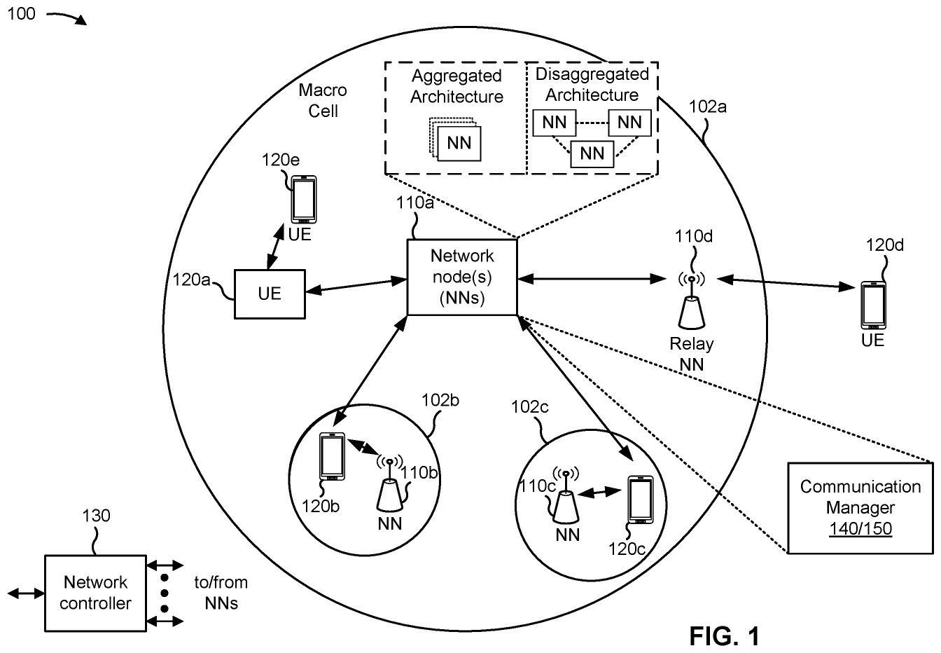

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, one or more memories) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHZ) and FR2 (24.25 GHz-52.6 GHz. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a distributed node may include a communication manager 140. As described in more detail elsewhere herein, the communication manager 140 may transmit, in association with a service server, a path switch request message indicating to configure a path between the service server and the distributed node; receive an acknowledgement of the path switch request message; and communicate with the service server on the path. Additionally, or alternatively, the communication manager 140 may perform one or more other operations described herein.

In some aspects, a service server may include a communication manager 150. As described in more detail elsewhere herein, the communication manager 150 may receive, in association with a distributed node, a path switch request message indicating to configure a path between the service server and the distributed node; transmit an acknowledgement of the path switch request message; and configure the path to the distributed node. Additionally, or alternatively, the communication manager 150 may perform one or more other operations described herein.

As indicated above, FIG. 1 is provided as an example. Other examples may differ from what is described with regard to FIG. 1.

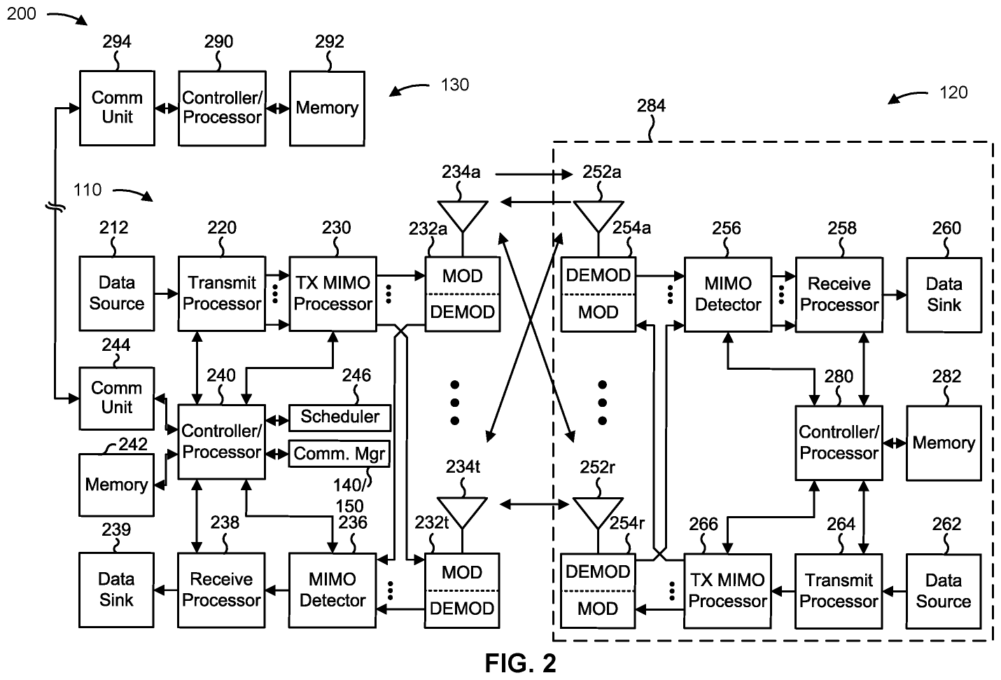

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥ 1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

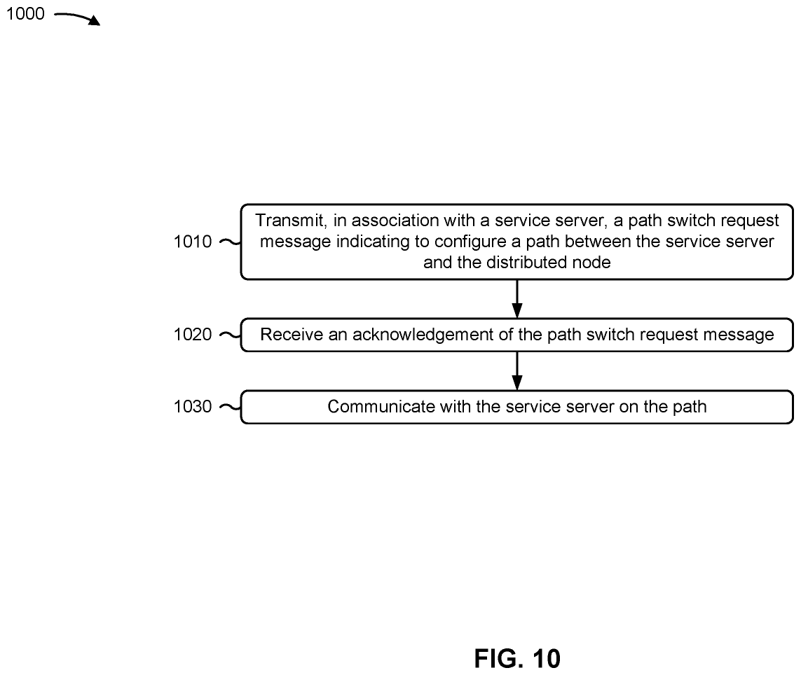

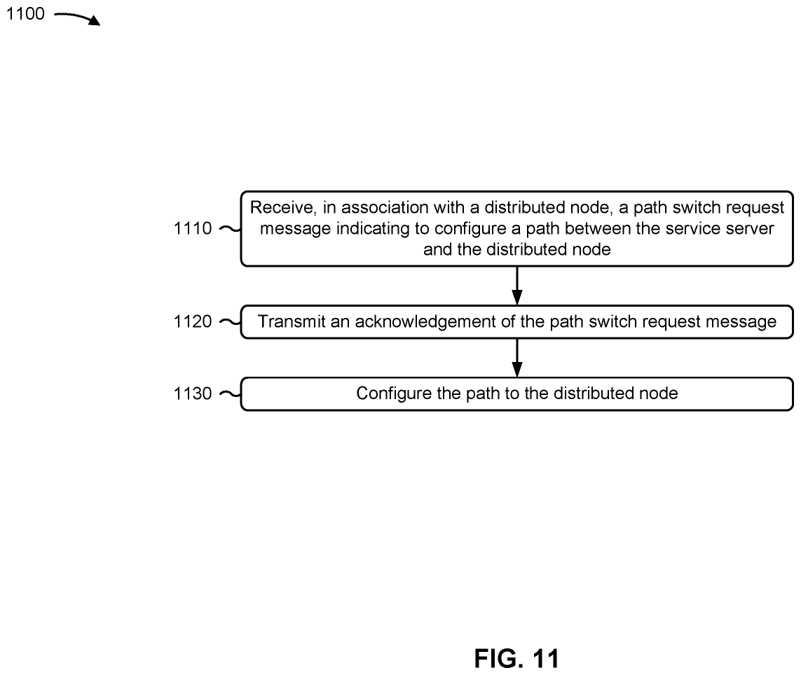

The controller/processor 240 of the network node 110, the controller/processor 280 of the UE 120, and/or any other component(s) of FIG. 2 may perform one or more techniques associated with service-based architecture, as described in more detail elsewhere herein. For example, the controller/processor 240 of the network node 110, the controller/processor 280 of the UE 120, and/or any other component(s) of FIG. 2 may perform or direct operations of, for example, method 1000 of FIG. 10, method 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 1000 of FIG. 10, method 1100 of FIG. 11, and/or other processes as described herein. In some examples, executing instructions may include running the instructions, converting the instructions, compiling the instructions, and/or interpreting the instructions, among other examples.

In some aspects, a distributed node (e.g., network node 110) includes means for transmitting, in association with a service server, a path switch request message indicating to configure a path between the service server and the distributed node; means for receiving an acknowledgement of the path switch request message; and/or means for communicating with the service server on the path. In some aspects, the means for the distributed node to perform operations described herein may include, for example, one or more of communication manager 140, transmit processor 220, TX MIMO processor 230, modem 232, antenna 234, MIMO detector 236, receive processor 238, controller/processor 240, memory 242, or scheduler 246.

In some aspects, a service server includes means for receiving, in association with a distributed node, a path switch request message indicating to configure a path between the service server and the distributed node; means for transmitting an acknowledgement of the path switch request message; and/or means for configuring the path to the distributed node. In some aspects, the means for the service server to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

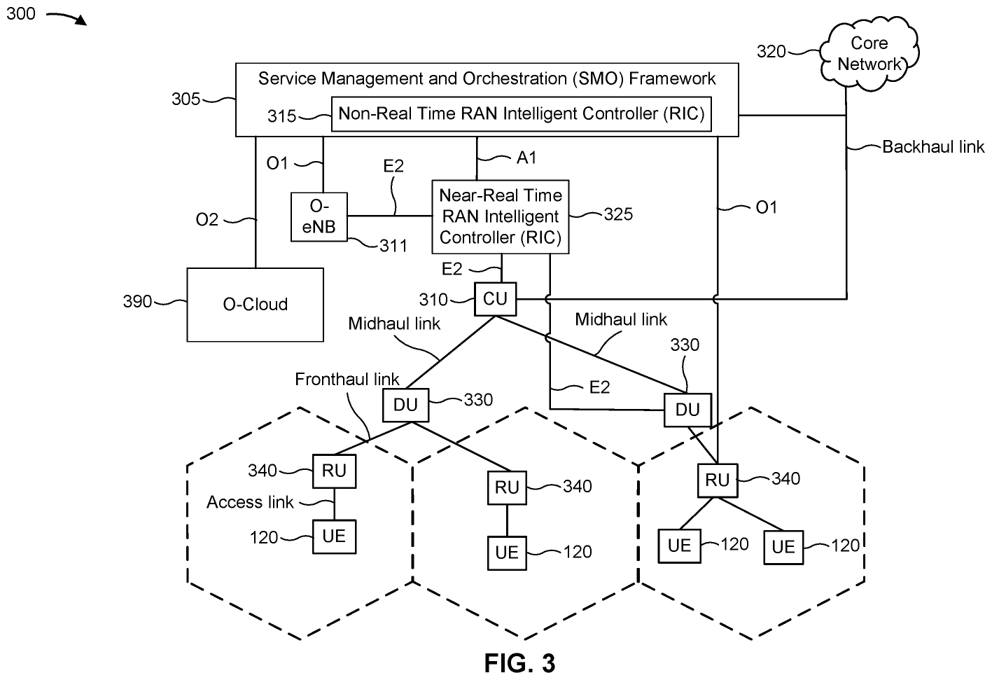

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). The disaggregated base station architecture 300 may be referred to as a divergent core network and RAN architecture, since some network functions (e.g., security, data routing, mobility) may be performed in part at the core network 320 and in part at the RAN (e.g., the CU 310 or the DU 330). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340. In some aspects, a DU 330 may include communication manager 140.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open NB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

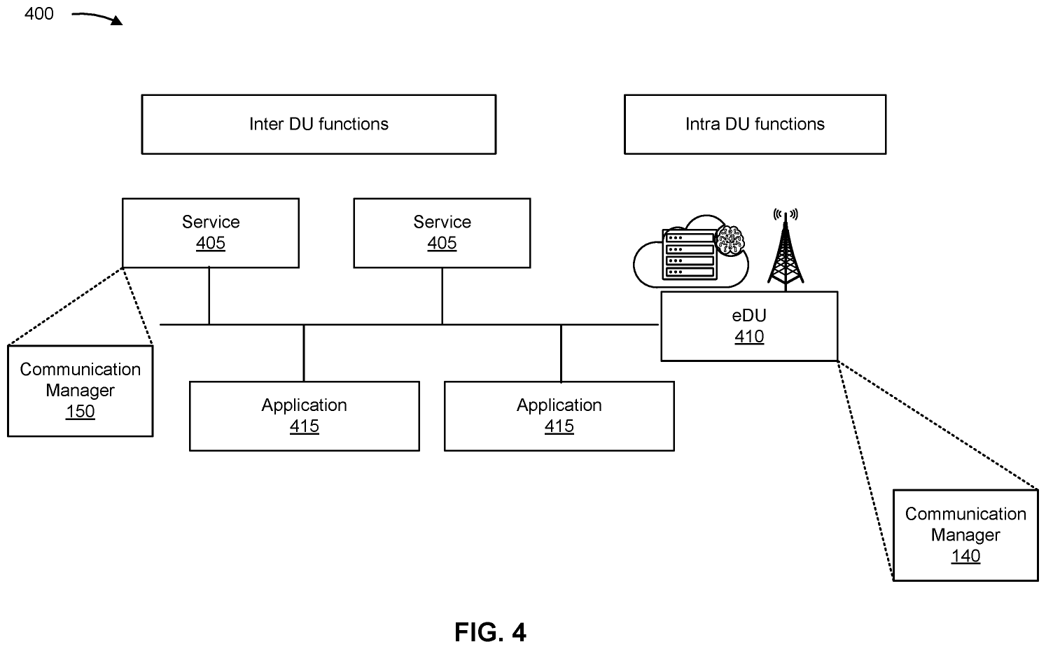

FIG. 4 is a diagram illustrating an example 400 of a service-based architecture 400, in accordance with the present disclosure.

The proliferation of cloud networks facilitates deployment of the service-based architecture 400. For example, a cloud-native platform may enable a merger of core network (CN) services (e.g., functions) and RAN services (e.g., functions), which may simplify protocols and reduce duplication of services across the CN and the RAN. The service-based architecture 400 includes services 405, an enhanced DU (eDU) 410, and a set of applications 415. A service 405 may be configured with an interface such as an application programming interface (API), and may be implemented by a service server, which may be a device or a cloud implementation. An application 415 or an eDU 410 may interact with the service 405 using the interface. For example, a paging service 405 may trigger CN paging or RAN paging by interacting with the eDU 410 via the interface. Services 405 of the service-based architecture 400 may be hosted based on the deployment topology, and based on capabilities and requirements for each service 405.

An eDU 410 may include a network node (e.g., a network node 110, a DU 330) capable of communicating with service 405. For example, inter-DU functions (e.g., functions involving communication between eDUs 410, such as mobility management) may be handled by a service 405, whereas intra-DU functions (such as PHY-layer functions and some medium access control (MAC) layer functions) may be handled by an eDU 410. For example, real-time link management may occur at the edge of the RAN (e.g., the eDU 410), which allows for more efficient activation, deactivation, and selection of features based on user experience requirements, and which decouples configuration and activation of performance-sensitive features.

In a divergent architecture, a number of network functions in the CN (e.g., core network 320) may handle operations relating to the CN, such as connection state management (e.g., idle and inactive state management), CN paging, network capability signaling, mobility, and non-access stratum (NAS) security. A RAN node, such as a CU (e.g., CU 310, a CU-CP, a CU-UP) or a DU (e.g., DU 330) may handle operations relating to the RAN, such as access-stratum (AS) security, mobility, UE radio capability signaling, RAN paging, connection management, and radio bearer (e.g., signaling radio bearer (SRB) or data radio bearer (DRB)) management. Thus, the divergent architecture provides a hierarchy between the CN and the RAN. This hierarchy may provide for deployment to meet performance and security requirements, and may facilitate accessibility of on-site equipment.

A service-based architecture 400 may differ from a divergent architecture in that services or functions related to a given functionality (such as mobility) may be performed by a single service server (e.g., service 405) rather than by a combination of a CN function (e.g., an access and mobility management function (AMF), a user plane function (UPF), a session management function (SMF), or another core network function) and a RAN node. For example, rather than a CN function and a RAN node communicating with one another to execute a mobility operation for a UE or an eDU 410, the eDU 410 may interface with a mobility service 405, which may handle selection of a target eDU and configuration or other signaling related to the mobility operation.

As indicated above, FIG. 4 is provided as an example. Other examples may differ from what is described with regard to FIG. 4.

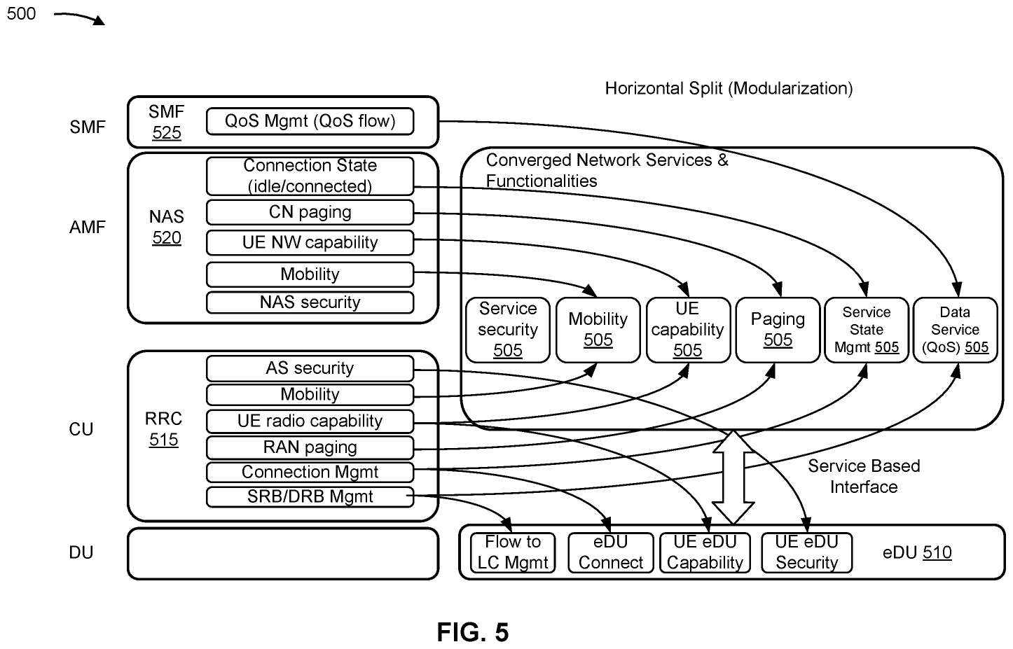

FIG. 5 is a diagram illustrating an example 500 of a protocol configuration for a service-based architecture, in accordance with the present disclosure. Example 500 includes a number of services 505 (e.g., service 405), which may be implemented by one or more service servers. In example 500, a divergent architecture is shown. The divergent architecture includes a DU (e.g., DU 330) which may implement PHY, MAC, and/or RLC functions. The divergent architecture also includes a CU which may implement radio resource control (RRC) functions 515, shown as AS security, mobility, UE radio capability signaling, RAN paging, connection management, and SRB/DRB management. The divergent architecture also includes core network nodes, shown as an AMF and an SMF. The AMF may implement NAS functions 520, such as connection state management, CN paging, UE network capability signaling, mobility, and NAS security. In some aspects, the core network nodes may include a UPF, which may implement AS functions. The SMF may implement an SMF function 525 such as quality of service (QoS) management, such as according to QoS flows.

A service-based architecture (e.g., service-based architecture 400) may include an eDU 510 (e.g., eDU 410) and a set of services 505. An arrow from a given function of the divergent architecture (e.g., RRC functions 515, NAS functions 520, SMF functions 525) to a corresponding service 505 indicates that the given function is handled by the corresponding service 505. As shown, a security service 505 may handle both NAS security and AS security. A mobility service may handle the CU's mobility functions as well as the AMF's mobility functions. A UE capability service may handle both UE radio capability and UE network capability functions. A paging service 505 may handle both CN paging and UE RAN paging. A service state management service may handle both connection management and connection state management. A data service (e.g., QoS service) may handle both QoS management and SRB/DRB management. Furthermore, the eDU 510 may implement certain functionality, such as QoS flow to logical channel management, eDU connectivity, UE eDU capability functionality, and eDU security. Thus, real-time link management may be handled at the RAN edge.

Thus, services of the network (e.g., the CN and the RAN) are modularized and consolidated instead of being spread across RAN nodes and CN nodes, which improves scalability, resiliency, elasticity, agility, reuse, visibility, automation, and failover handling. In this way, wireless communication networks are adapted to effectively handle cloud-native deployment.

As indicated above, FIG. 5 is provided as an example. Other examples may differ from what is described with regard to FIG. 5.

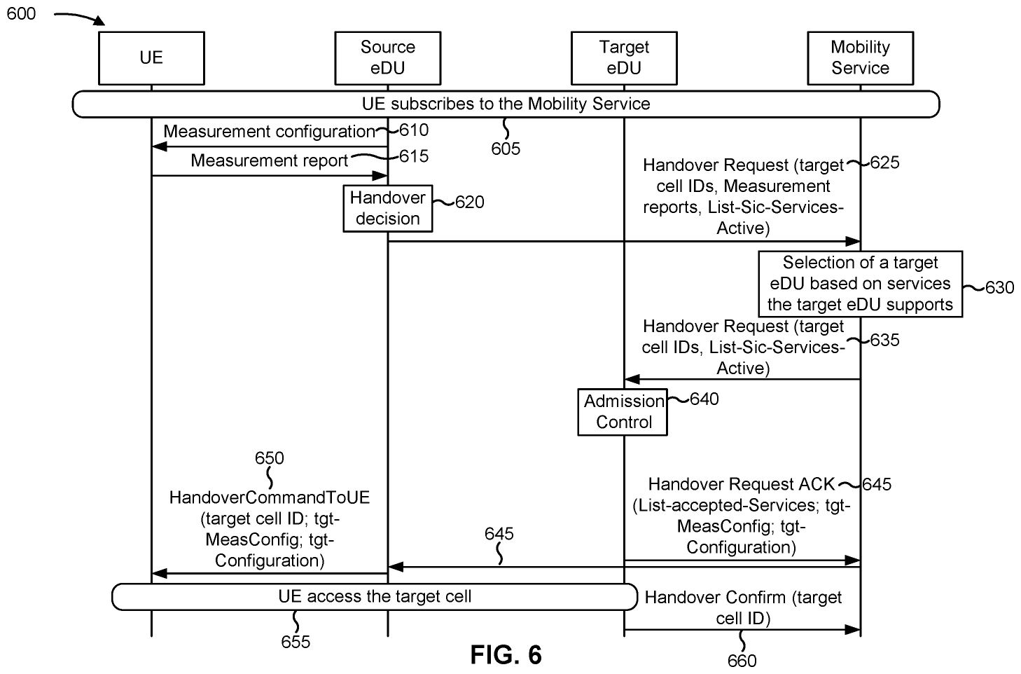

FIG. 6 is a diagram illustrating an example 600 of inter-eDU handover, in accordance with the present disclosure. Example 600 includes a UE (e.g., UE 120), a source eDU (e.g., eDU 410, eDU 510), a target eDU (e.g., eDU 410, eDU 510), and a mobility service (e.g., service 405, service 505). Example 600 is an example where the source eDU configures measurements and performs handover decisions. In example 600, the UE is initially connected to a cell associated with (e.g., provided by) the source eDU.

As shown by reference number 605, the UE may subscribe to the mobility service. For example, the UE may exchange signaling with the mobility service to establish a relationship with the mobility service. In some aspects, the mobility service may handle the inter-eDU handover based at least in part on the UE being subscribed to the mobility service.

As shown by reference number 610, the source eDU may transmit, and the UE may receive, a measurement configuration. The measurement configuration may indicate a configuration (e.g., a resource, a resource set, a measurement to be performed, a measurement threshold, target cells) for measuring a set of target cells. As shown by reference number 615, the UE may transmit, and the source eDU may receive, a measurement report. The measurement report may indicate measurement values corresponding to one or more target cells or one or more target eDUs. As shown by reference number 620, the source eDU may perform a handover decision. For example, the source eDU may determine to perform a handover of the UE according to the measurement report.

As shown by reference number 625, the source eDU may transmit a handover request to the mobility service. The handover request may include one or more target cell identifiers (e.g., based at least in part on the measurement report), one or more measurement reports which may be associated with the one or more target cell identifiers, and a list of active services (e.g., service 405, service 505) associated with the UE or the source eDU.

As shown by reference number 630, the mobility service may select a target eDU for the handover. For example, the mobility service may select a target eDU based at least in part on a set of services supported by the target eDU. In some aspects, the mobility service may select a target eDU that supports one or more services also supported by the source eDU. In some aspects, the mobility service may select a target eDU that supports all services supported by the source eDU. In some aspects, the mobility service may select a target eDU that supports one or more services, supported by the source eDU, that are associated with a threshold importance level. In some aspects, the mobility service may select a target cell associated with the target eDU. For example, the mobility service may select the target eDU for the handover, and may identify a target cell provided by the target eDU. As another example, the mobility service may identify a target cell according to the measurement report, and may select a target eDU associated with the target cell based at least in part on the services supported by the target eDU.

As shown by reference number 635, the mobility service may transmit, and the target eDU may receive, a handover request. The handover request may indicate a target cell identifier (e.g., for a target cell provided by the target eDU), which may be selected from the one or more target cell identifiers indicated by the handover request shown by reference number 625. The handover request may also indicate one or more services, such as the one or more services indicated in the handover request shown by reference number 625.

As shown by reference number 640, the target eDU may perform admission control. Admission control may include determining whether handover of the UE from the source eDU to the target eDU is permitted or is accepted by the target eDU. As shown by reference number 645, the target eDU may acknowledge the handover request by transmitting an acknowledgement of the handover request to the mobility service, and the mobility service may forward the acknowledgement to the source eDU. In some other examples, the target eDU may reject the handover request (not shown).

The acknowledgement of the handover request may include information indicating one or more accepted services (e.g., a list of accepted services) of the one or more services indicated by the handover request, a target measurement configuration (e.g., indicating measurements for the UE to perform once connected to the target cell or before connecting to the target cell), a target configuration (e.g., indicating one or more parameters for communicating with or on the target cell or with the target eDU), or the like.

As shown by reference number 650, the source eDU may transmit, and the UE may receive, a handover command. The handover command may indicate the target cell identifier, the target measurement configuration, and/or the target configuration. As shown by reference number 655, the UE may access a target cell associated with the target eDU. For example, the UE may access the target cell in accordance with the handover command (e.g., the handover command may trigger the UE to access the target cell). As shown by reference number 660, the target eDU may transmit a handover confirmation to the mobility service.

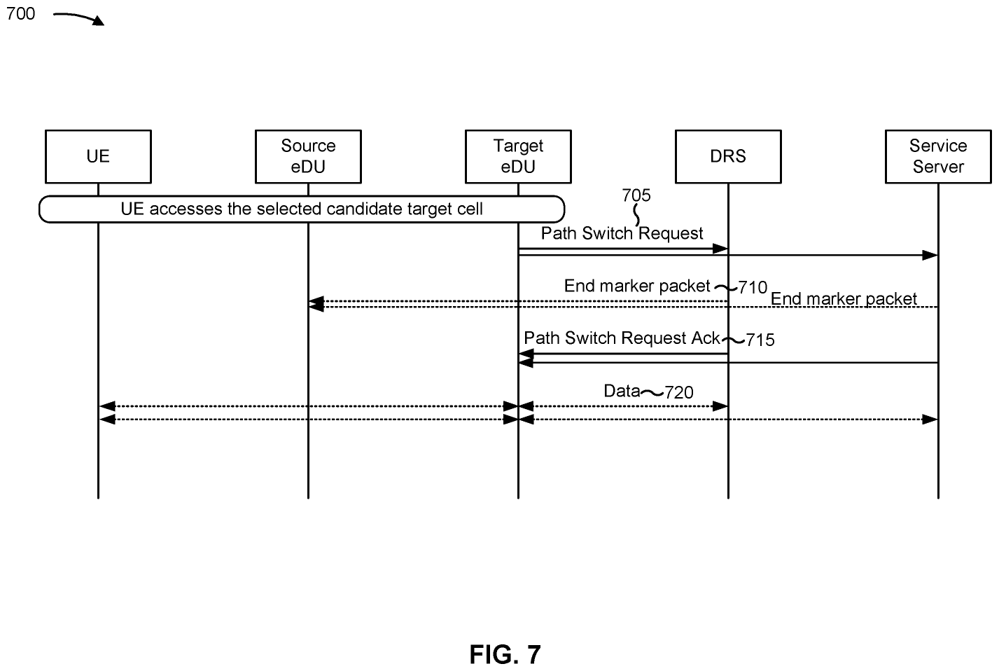

After the handover is complete, the target eDU may request a path switch such that data sessions (e.g., protocol data unit (PDU) sessions) are switched from a path associated with the source eDU to a path associated with the target eDU. FIGS. 7-9 provide examples of the path switch procedure.

As indicated above, FIG. 6 is provided as an example. Other examples may differ from what is described with regard to FIG. 6.

FIG. 7 is a diagram illustrating an example 700 of a path switch from a source eDU to a target eDU, in accordance with the present disclosure. In example 700, the target eDU performs a path switch procedure with a data routing service (DRS) and a service server without the involvement of an intermediary node. Example 700 includes a UE (e.g., UE 120), a source eDU (e.g., eDU 410, eDU 510, the source eDU of FIG. 6), a target eDU (e.g., eDU 410, eDU 510, the target eDU of FIG. 6), a DRS (e.g., service 405, service 505, a service server), and a service server (e.g., service 405, service 505). In example 700, the UE and the target eDU may have previously performed at least part of the operations of example 600 of FIG. 6. The source eDU may transmit, to the target eDU (e.g., during handover preparation), information indicating an address of the DRS and/or an address of the service server.

As shown in FIG. 7, the UE may access a target cell (as mentioned in connection with reference number 655 of FIG. 6). For example, the UE may access a selected candidate target cell provided by the target eDU upon completion of a connected-state handover (e.g., in a handover completion phase) of the UE from the source eDU to the target eDU. Thus, the UE may be in a connected state with regard to the target cell, after having completed access of the target cell.

As shown by reference number 705, the target eDU may transmit a path switch request message to the DRS and/or the service server. A path switch may include transfer of information regarding a UE, such as a UE's control plane context and/or user plane context, from the source eDU to the target eDU. After a path switch is performed, services and data transfer may occur between the DRS and/or service server and the target eDU instead of between the DRS and/or service server and the source eDU. Thus, a path may include at least one of information indicating an eDU serving a given UE, or information indicating a data or control signaling route for a UE (e.g., involving an eDU and/or a service server).

The target eDU may transmit the path switch request message after completing the mobility operation (e.g., connected-state handover) of the UE. The path switch request message transmitted to a DRS may include information indicating a set of accepted data sessions (e.g., protocol data unit (PDU) sessions accepted by the target eDU), tunnel information (e.g., access network (AN) tunnel information, which may include information indicating target eDU addresses for forwarding packets and/or a quality of service (QOS) flow identifier (QFI) for the target eDU addresses), and/or information indicating a set of rejected data sessions (e.g., PDU sessions). The path switch request message transmitted to a service server may include, if the service is accepted by the target eDU for handover, one or more target eDU addresses for forwarding packets by the service server, and/or information indicating if the service is not accepted by the target eDU for handover.

As shown by reference number 710, the DRS and/or the service server may transmit, and the source eDU may receive, an end marker packet. The end marker packet may indicate to the source eDU that there are no more packets to be transmitted over a connection to the source eDU.

As shown by reference number 715, the DRS and/or the service server may transmit a path switch request acknowledgement message (sometimes referred to as an acknowledgement of a path switch request message) to the target eDU. For example, the DRS and/or the service server may transmit the path switch request acknowledgement message in response to the path switch request message shown by reference number 705. In some aspects, the path switch request acknowledgement message may include tunnel information for the DRS and/or the service server (e.g., core network tunnel information) for each accepted data session (e.g., PDU session). For example, the path switch request acknowledgement message may include an address of the service server or the DRS for data forwarding. For example, the service server may provide the address only if the service is accepted by the target eDU for handover.

As shown by reference number 720, the target eDU may communicate user data or other information associated with a service with the DRS and/or the service server. For example, the target eDU may communicate user data with the DRS using addresses of the target eDU and the DRS, as indicated above. As another example, the target eDU may communicate information associated with a service with the service server using addresses of the target eDU and the DRS, as indicated above. Thus, the target eDU may communicate with the service server and/or DRS on the path between the target eDU and the service server and/or DRS. The target eDU may also communicate with the UE, such as based at least in part on or including the data shown by reference number 720.

As indicated above, FIG. 7 is provided as an example. Other examples may differ from what is described with regard to FIG. 7.

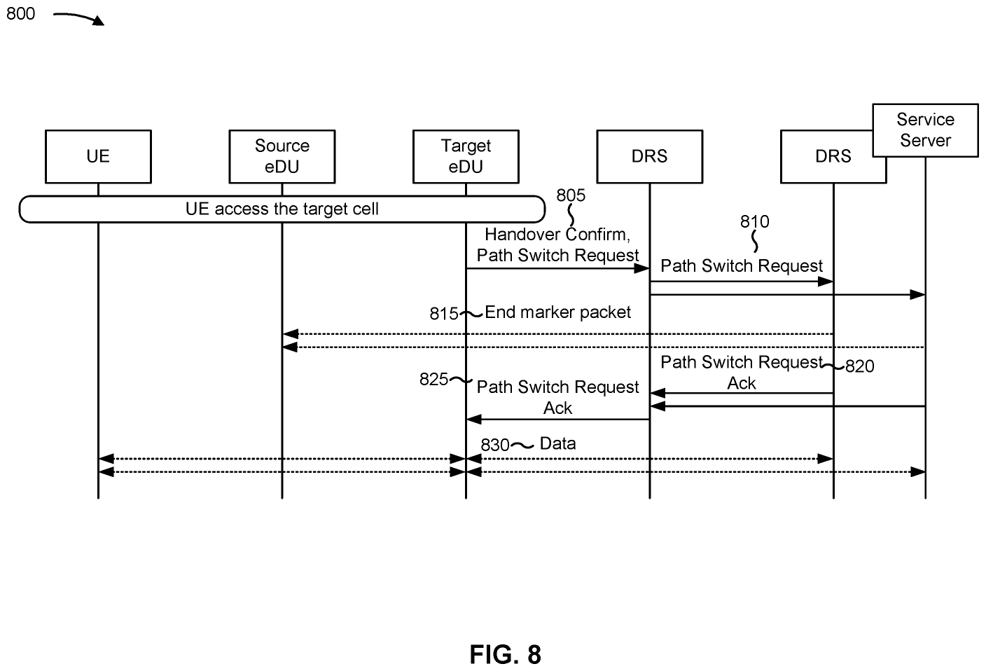

FIG. 8 is a diagram illustrating an example 800 of a path switch from a source eDU to a target eDU, in accordance with the present disclosure. In example 800, the target eDU may perform a path switch procedure with the involvement of a mobility service as an intermediary node. Example 800 includes a UE (e.g., UE 120), a source eDU (e.g., eDU 410, eDU 510, the source eDU of FIG. 6), a target eDU (e.g., eDU 410, eDU 510, the target eDU of FIG. 6), a mobility service (e.g., service 405, service 505, a service server), a DRS (e.g., service 405, service 505, a service server), and a service server (e.g., service 405, service 505). In example 800, the service server and the DRS are illustrated as partially overlapped since similar signaling may be transmitted to and by the service server and the DRS (though the signaling may differ in content, source, or destination). In example 800, the UE and the target eDU may have previously performed at least part of the operations of example 600 of FIG. 6.

As shown in FIG. 8, the UE may access a target cell (as mentioned in connection with reference number 655 of FIG. 6). For example, the UE may access a selected candidate target cell provided by the target eDU upon completion of a connected-state handover of the UE from the source eDU to the target eDU. Thus, the UE may be in a connected state with regard to the target cell, after having completed access of the target cell.

As shown by reference number 805, the target eDU may transmit a path switch request message to the mobility service. The target eDU may also transmit a handover confirmation to the mobility service indicating that the connected-state handover is complete. The handover confirmation and the path switch request message may be the same communication or different communications. As shown by reference number 810, the mobility service may transmit a path switch request message to the DRS and/or the service server. The path switch request message indicated by reference number 810 may be a forwarded version of the path switch request message indicated by reference number 805, or may include at least part of the information included in the path switch request message indicated by reference number 805. A path switch may include transfer of information regarding a UE, such as a UE's control plane context and/or user plane context, from the source eDU to the target eDU. After a path switch is performed, services and data transfer may occur between the DRS and/or service server and the target eDU instead of between the DRS and/or service server and the source eDU. Thus, a path may include at least one of information indicating an eDU serving a given UE, or information indicating a data or control signaling route for a UE (e.g., involving an eDU and/or a service server).

The target eDU may transmit the path switch request message after completing the mobility operation (e.g., connected-state handover) of the UE. The path switch request message transmitted for a DRS (e.g., via the mobility service) may include information indicating a set of accepted data sessions (e.g., protocol data unit (PDU) sessions accepted by the target eDU), tunnel information (e.g., access network (AN) tunnel information, which may include information indicating target eDU addresses for forwarding packets and/or a quality of service (QOS) flow identifier (QFI) for the target eDU addresses), and/or information indicating a set of rejected data sessions (e.g., PDU sessions). The path switch request message transmitted for a service server (e.g., via the mobility service) may include, if the service is accepted by the target eDU for handover, one or more target eDU addresses for forwarding packets by the service server, and/or information indicating if the service is not accepted by the target eDU for handover.

As shown by reference number 815, the DRS and/or the service server may transmit, and the source eDU may receive, an end marker packet, as described with regard to reference number 715 of FIG. 7.

As shown by reference number 820, the DRS and/or the service server may transmit a path switch request acknowledgement message to the mobility service. As shown by reference number 825, the mobility service may transmit a path switch request acknowledgement message to the target eDU. For example, the DRS and/or the service server may transmit the path switch request acknowledgement message in response to the path switch request shown by reference number 805 or by reference number 810. The path switch request acknowledgement message indicated by reference number 825 may be a forwarded version of the path switch request acknowledgement message indicated by reference number 820, or may include at least part of the information included in the path switch request acknowledgement message indicated by reference number 820. In some aspects, the path switch request acknowledgement message may include tunnel information for the DRS and/or the service server (e.g., core network tunnel information) for each accepted data session (e.g., PDU session). For example, the path switch request acknowledgement message may include an address of the service server or the DRS for data forwarding. For example, the service server may provide the address only if the service is accepted by the target eDU for handover.

As shown by reference number 830, the target eDU may communicate user data or other information associated with a service with the DRS and/or the service server. For example, the target eDU may communicate user data with the DRS using addresses of the target eDU and the DRS, as indicated above. As another example, the target eDU may communicate information associated with a service with the service server using addresses of the target eDU and the DRS, as indicated above. Thus, the target DU may communicate with the service server and/or DRS on the path between the target eDU and the service server and/or DRS.

As indicated above, FIG. 8 is provided as an example. Other examples may differ from what is described with regard to FIG. 8.

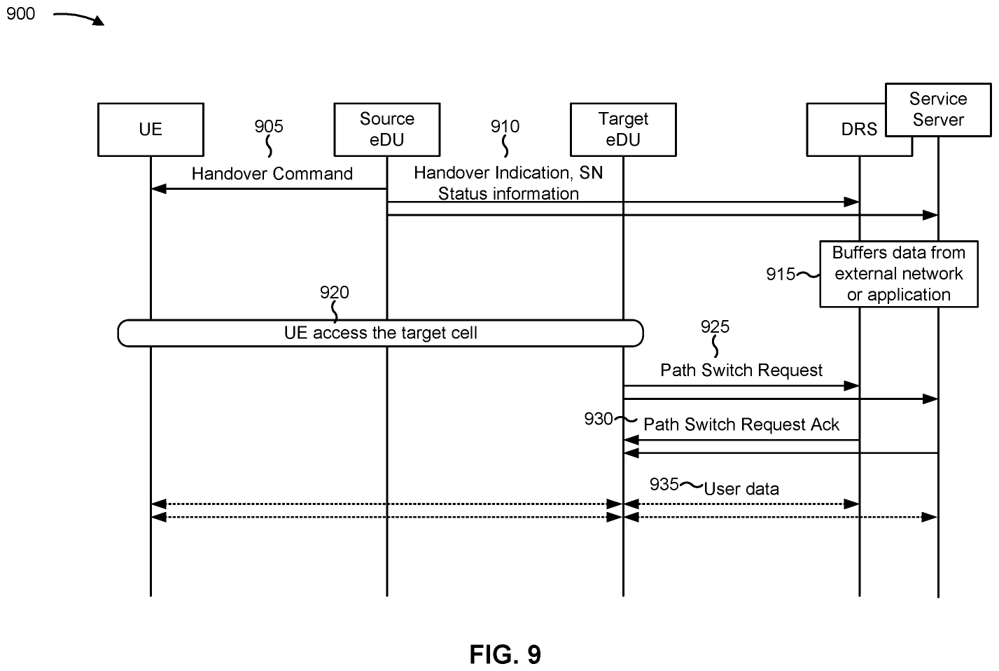

FIG. 9 is a diagram illustrating an example 900 of a path switch from a source eDU to a target eDU, in accordance with the present disclosure. Example 900 includes a UE (e.g., UE 120), a source eDU (e.g., eDU 410, eDU 510, the source eDU of FIG. 6), a target DU (e.g., eDU 410, eDU 510, the target eDU of FIG. 6), a DRS (e.g., service 405, service 505, a service server), and a service server (e.g., service 405, service 505). In example 900, the UE and the target eDU may have previously performed at least part of the operations of example 600 of FIG. 6. In example 900, data forwarding is performed at the DRS and/or the service server.

As shown by reference number 905, the source eDU may transmit a handover command to the UE, as described in connection with reference number 650 of FIG. 6.

As shown by reference number 910, the source eDU may transmit, to the DRS and/or the service server, a handover indication. The handover indication may include sequence number (SN) status information. An SN is an identifier assigned to data (e.g., a packet, a PDU, a service data unit (SDU), etc.) to assist in ordering of communications including the data. By providing the SN status information to the DRS and/or the service server, the source eDU enables the DRS and/or the service server to identify a packet, PDU, or SDU at which the DRS and/or service server should start buffering data and/or forwarding the data to the target eDU, thus reducing interruption to communication with the UE in connection with the path switch or handover.

As shown by reference number 915, the DRS and/or the service server may buffer data from an external network or application. For example, upon receiving the handover indication shown by reference number 905, the DRS and the Service server may stop transmitting data toward the source eDU and may start buffering data from the external network or application. In this case, upon receiving the path switch request message, the DRS or the Service server does not need to transmit end marker packets to the source eDU because data transmission from the DRS/Service server to the source eDU may stop upon receiving a handover indication from the source eDU.

As shown by reference number 920, the UE may access a target cell, as described in connection with reference number 655 of FIG. 6.

As shown by reference number 925, the target eDU may transmit a path switch request message to the DRS and/or the service server (e.g., directly or via a mobility service). The path switch request message may include any of the information described as being included in a path switch request in connection with FIGS. 7 and 8. As shown by reference number 930, the DRS and/or the service server may transmit a path switch request acknowledgement message to the target eDU. The path switch request acknowledgement message may include any of the information described as being included in a path switch request acknowledgement in connection with FIGS. 7 and 8.

As shown by reference number 935, the target eDU may communicate user data or other information associated with a service with the DRS and/or the service server. Thus, the target eDU may communicate with the service server and/or DRS on the path between the target eDU and the service server and/or DRS. For example, the DRS and/or the service server may provide buffered data (buffered as described in connection with reference number 915) to the target eDU. In this way, data forwarding is performed at the DRS and/or service server. Thus, interruption of data communication between the UE and the network is reduced.

As indicated above, FIG. 9 is provided as an example. Other examples may differ from what is described with regard to FIG. 9.

FIG. 10 is a flowchart of an example method 1000 of wireless communication. The method 1000 may be performed by, for example, a distributed node (e.g., network node 110, DU 330, eDU 410, eDU 510, the target eDU of FIGS. 6-9).

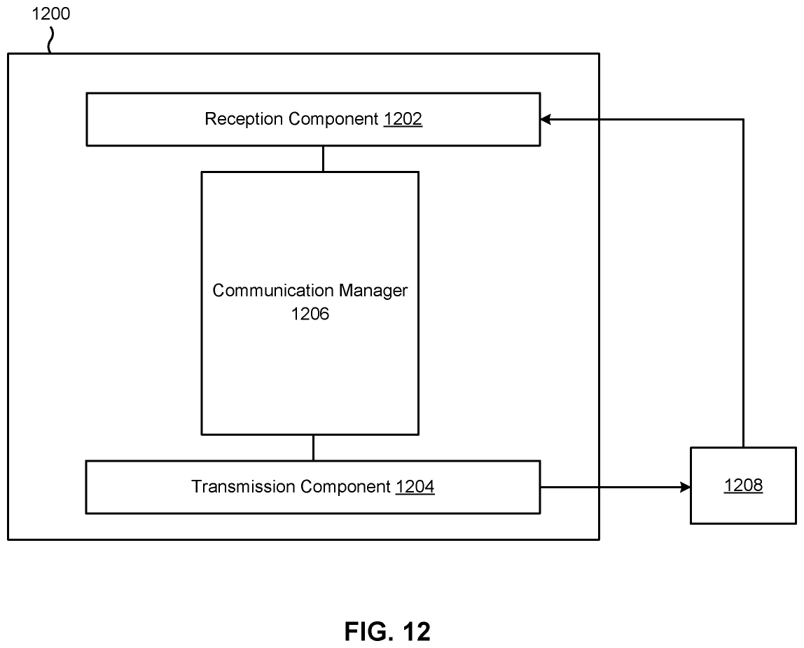

At 1010, the distributed node may transmit, in association with a service server, a path switch request message indicating to configure a path between the service server and the distributed node. For example, the distributed node (e.g., using communication manager 1206 and/or transmission component 1204, depicted in FIG. 12) may transmit, in association with a service server, a path switch request message indicating to configure a path between the service server and the distributed node, as described above in connection with, for example, reference numbers 705, 805, 810, and 925. The distributed node may transmit the path switch request message in association with the service server in that the path switch request message is transmitted directly to the service server or to the service server via a mobility service. The path switch request message may indicate to configure a path between the service server and the distributed node in that the path switch request message may indicate an address of the distributed node and/or an accepted data session. The service server may include a DRS (e.g., for user data) or another service server corresponding to a service (e.g., for data or control signaling for a service). In some aspects, transmitting the path switch request message may include transmitting the path switch request message during a completion phase of a handover (e.g., handover completion) in which the distributed node is a target distributed node (e.g., target eDU).

In some aspects, the path switch request message includes at least one of a distributed node address for a data session (e.g., PDU session), a distributed node address for a service, information indicating a rejected data session, or information indicating a rejected service.

At 1020, the distributed node may receive an acknowledgement of the path switch request message. For example, the distributed node (e.g., using communication manager 1206 and/or reception component 1202, depicted in FIG. 12) may receive an acknowledgement of the path switch request message, as described above in connection with, for example, reference numbers 715, 820, 825, and 930. The distributed node may receive the acknowledgement from the service server or from a mobility service. In some aspects, the acknowledgement indicates a service server address of the service server.

At 1030, the distributed node may communicate with the service server on the path. For example, the distributed node (e.g., using communication manager 1206, reception component 1202, and/or transmission component 1204, depicted in FIG. 12) may communicate with the service server on the path, as described above in connection with, for example, reference numbers 720, 830, and 935.

In some aspects, alone or in combination with one or more of the first through seventh aspects, method 1000 includes receiving, from the service server, buffered data associated with a handover in which the distributed node is a target distributed node.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed by, for example, a service server (e.g., service 405, service 505, the DRS of FIGS. 7-9, the service server of FIGS. 7-9).

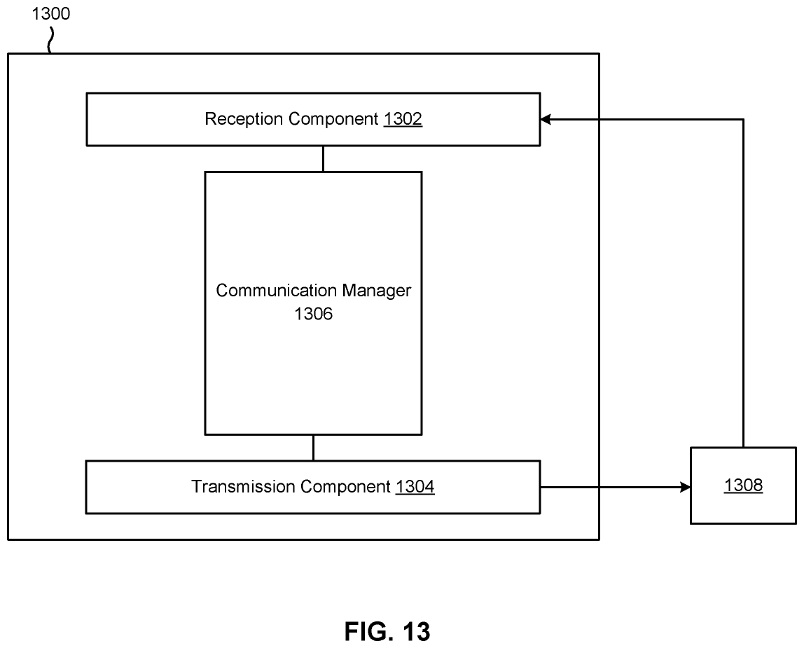

At 1110, the service server may receive, in association with a distributed node, a path switch request message indicating to configure a path between the service server and the distributed node. For example, the service server (e.g., using communication manager 1306 and/or reception component 1302, depicted in FIG. 13) may receive, in association with (e.g., from) a distributed node, a path switch request message indicating to configure a path between the service server and the distributed node, as described above in connection with, for example, reference numbers 705, 805, 810, and 925. The service server may receive the path switch request message in association with the distributed node in that the path switch request message is received directly from the distributed node or from the distributed node via a mobility service. The path switch request message may indicate to configure a path between the service server and the distributed node in that the path switch request message may indicate an address of the distributed node and/or an accepted data session. The service server may include a DRS (e.g., for user data) or another service server corresponding to a service (e.g., for data or control signaling for a service). In some aspects, receiving the path switch request message may include receiving the path switch request message during a completion phase of a handover in which the distributed node is a target distributed node (e.g., target eDU). In some aspects, the path switch request message includes at least one of a distributed node address for a data session, a distributed node address for a service, information indicating a rejected data session, or information indicating a rejected service.

At 1120, the service server may transmit an acknowledgement of the path switch request message. For example, the service server (e.g., using communication manager 1306 and/or transmission component 1304, depicted in FIG. 13) may transmit an acknowledgement of the path switch request message, as described above in connection with, for example, reference numbers 715, 820, 825, and 930. The service server may transmit the acknowledgement to the distributed node directly or via a mobility service. In some aspects, the acknowledgement indicates a service server address of the service server.

At 1130, the service server may communicate on the path to the distributed node. For example, the service server (e.g., using communication manager 1306 and/or transmission component 1304, depicted in FIG. 13) may communicate on the path to the distributed node, as described above in connection with, for example, reference numbers 720, 830, and 935.

In some aspects, alone or in combination with one or more of the first through seventh aspects, method 1100 includes transmitting, to the distributed node, buffered data associated with a handover in which the distributed node is a target distributed node.

In some aspects, alone or in combination with one or more of the first through eighth aspects, method 1100 includes receiving, from a source distributed node of the handover and prior to transmitting the buffered data, a handover indication, and buffering the buffered data in association with the handover indication.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a diagram of an example apparatus 1200 for wireless communication, in accordance with the present disclosure. The apparatus 1200 may be a distributed node (e.g., the distributed node of FIG. 10), or a distributed node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1208 (such as a UE, a base station, or another wireless communication device) using the reception component 1202 and the transmission component 1204. As further shown, the apparatus 1200 may include the communication manager 1206 (e.g., communication manager 140).

In some aspects, the apparatus 1200 may be configured to perform one or more operations described herein in connection with FIGS. 4-9. Additionally, or alternatively, the apparatus 1200 may be configured to perform one or more processes described herein, such as method 1000 of FIG. 10, or a combination thereof. In some aspects, the apparatus 1200 and/or one or more components shown in FIG. 12 may include one or more components of the distributed node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the distributed node described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the distributed node described in connection with FIG. 2. In some aspects, the transmission component 1204 may be co-located with the reception component 1202 in a transceiver.

The transmission component 1204 may transmit, in association with a service server, a path switch request message indicating to configure a path between the service server and the distributed node. The reception component 1202 may receive an acknowledgement of the path switch request message. The transmission component 1204 may communicate with the service server on the path.

The reception component 1202 may receive, from the service server, buffered data associated with a handover in which the distributed node is a target distributed node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a service server (e.g., the service server of FIG. 11), or a service server may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1308 (such as a UE, a base station, or another wireless communication device) using the reception component 1302 and the transmission component 1304. As further shown, the apparatus 1300 may include a communication manager 1306 (e.g., communication manager 150).

In some aspects, the apparatus 1300 may be configured to perform one or more operations described herein in connection with FIGS. 4-9. Additionally, or alternatively, the apparatus 1300 may be configured to perform one or more processes described herein, such as method 1100 of FIG. 11, or a combination thereof. In some aspects, the apparatus 1300 and/or one or more components shown in FIG. 13 may include one or more components of the service server described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the service server described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the service server described in connection with FIG. 2. In some aspects, the transmission component 1304 may be co-located with the reception component 1302 in a transceiver.

The reception component 1302 may receive, in association with a distributed node, a path switch request message indicating to configure a path between the service server and the distributed node. The transmission component 1304 may transmit an acknowledgement of the path switch request message. The transmission component 1304 may communicate on the path to the distributed node.

The transmission component 1304 may transmit, to the service server, buffered data associated with a handover in which the distributed node is a target distributed node.

The reception component 1302 may receive, from a source distributed node of the handover and prior to transmitting the buffered data, a handover indication.

The communication manager 1306 may buffer the buffered data in association with the handover indication.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

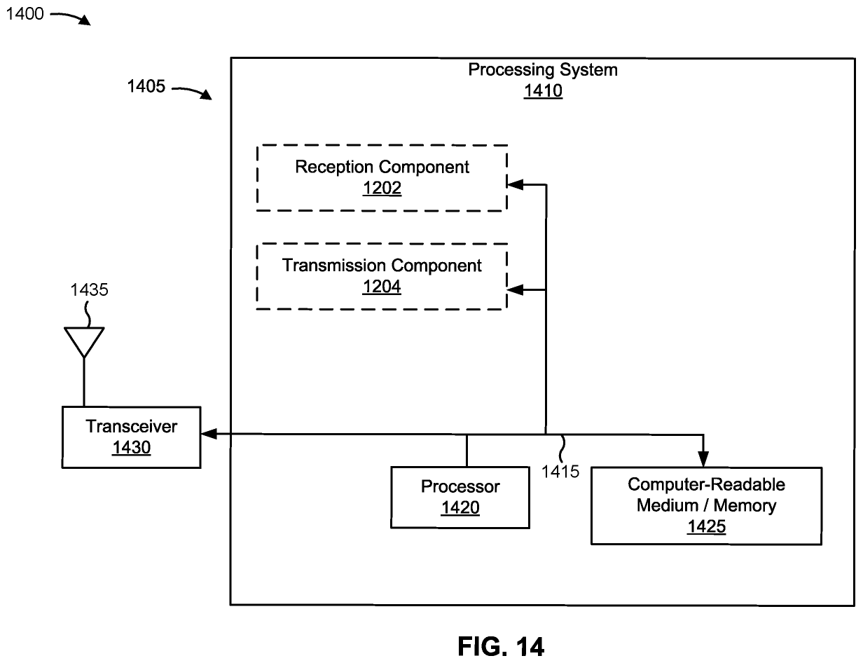

FIG. 14 is a diagram illustrating an example 1400 of a hardware implementation for an apparatus 1405 employing a processing system 1410, in accordance with the present disclosure. The apparatus 1405 may be a distributed node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1202. In addition, the transceiver 1430 receives information from the processing system 1410, specifically the transmission component 1204, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 110 and may include the memory 242 and/or at least one of the TX MIMO processor 230, the RX processor 238, and/or the controller/processor 240. In some aspects, the apparatus 1405 for wireless communication includes means for means for transmitting, in association with a service server, a path switch request message indicating to configure a path between the service server and the distributed node; means for receiving an acknowledgement of the path switch request message; and/or means for communicating with the service server on the path. The aforementioned means may be one or more of the aforementioned components of the apparatus 1200 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

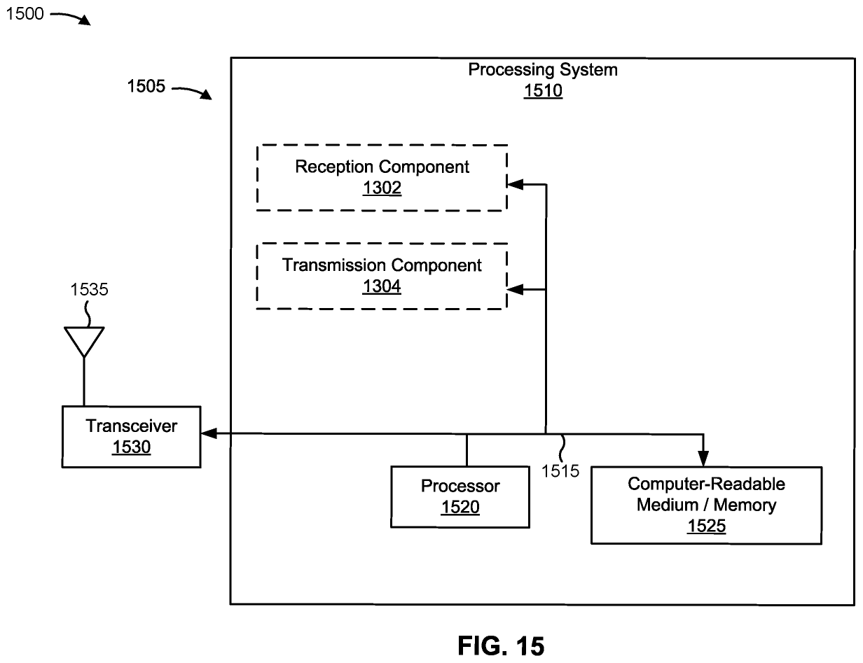

FIG. 15 is a diagram illustrating an example 1500 of a hardware implementation for an apparatus 1505 employing a processing system 1510, in accordance with the present disclosure. The apparatus 1505 may be a service server.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor 1520, the illustrated components, and the computer-readable medium/memory 1525. The bus 1515 may also link various other circuits, such as timing sources, peripherals, voltage regulators, and/or power management circuits.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1302. In addition, the transceiver 1530 receives information from the processing system 1510, specifically the transmission component 1304, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the device 1600. Additionally, or alternatively, the apparatus 1505 may be implemented in a cloud environment. In some aspects, the apparatus 1505 for wireless communication includes means for receiving, in association with a distributed node, a path switch request message indicating to configure a path between the service server and the distributed node; means for transmitting an acknowledgement of the path switch request message; and/or means for configuring the path to the distributed node. The aforementioned means may be one or more of the aforementioned components of the apparatus 1300 and/or the processing system 1510 of the apparatus 1505 configured to perform the functions recited by the aforementioned means.

FIG. 15 is provided as an example. Other examples may differ from what is described in connection with FIG. 15.

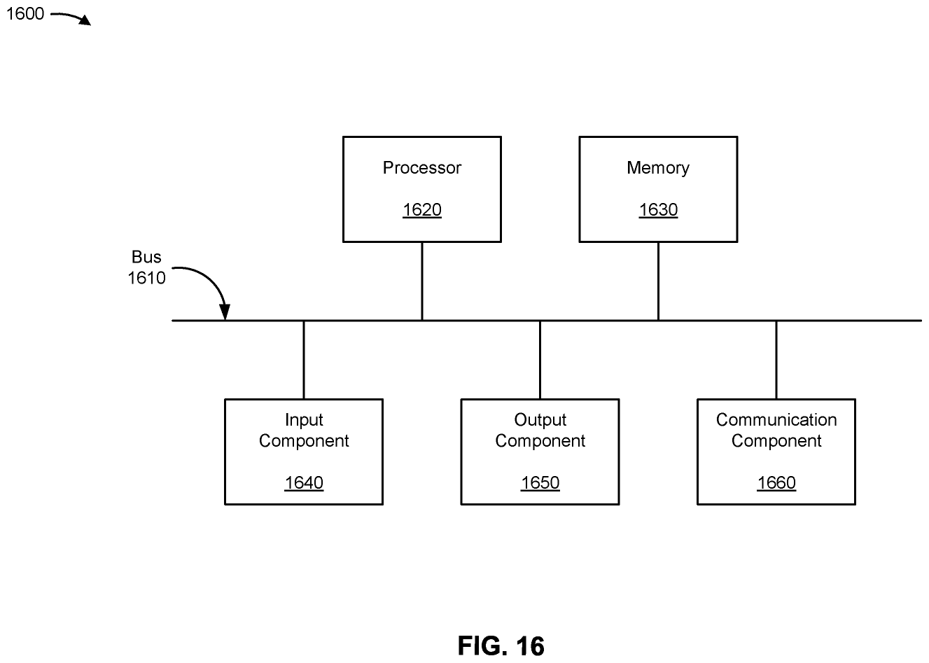

FIG. 16 is a diagram of example components of a device 1600 associated with path switch for connected state mobility. The device 1600 may correspond to a service server and/or a service. In some implementations, the service server of FIGS. 6-9 or the service server of FIG. 11 may include one or more devices 1600 and/or one or more components of the device 1600. As shown in FIG. 16, the device 1600 may include a bus 1610, a processor 1620 (which may include one or more processors), a memory 1630, an input component 1640, an output component 1650, and/or a communication component 1660.

The bus 1610 may include one or more components that enable wired and/or wireless communication among the components of the device 1600. The bus 1610 may couple together two or more components of FIG. 16, such as via operative coupling, communicative coupling, electronic coupling, and/or electric coupling. For example, the bus 1610 may include an electrical connection (e.g., a wire, a trace, and/or a lead) and/or a wireless bus. The processor 1620 may include a central processing unit, a graphics processing unit, a microprocessor, a controller, a microcontroller, a digital signal processor, a field-programmable gate array, an application-specific integrated circuit, and/or another type of processing component. The processor 1620 may be implemented in hardware, firmware, or a combination of hardware and software. In some implementations, the processor 1620 may include one or more processors capable of being programmed to perform one or more operations or processes described elsewhere herein.

The memory 1630 may include one or more memories. The memory 1630 may include volatile and/or nonvolatile memory. For example, the memory 1630 may include random access memory (RAM), read only memory (ROM), a hard disk drive, and/or another type of memory (e.g., a flash memory, a magnetic memory, and/or an optical memory). The memory 1630 may include internal memory (e.g., RAM, ROM, or a hard disk drive) and/or removable memory (e.g., removable via a universal serial bus connection). The memory 1630 may be a non-transitory computer-readable medium. The memory 1630 may store information, one or more instructions, and/or software (e.g., one or more software applications) related to the operation of the device 1600. In some implementations, the memory 1630 may include one or more memories that are coupled (e.g., communicatively coupled) to one or more processors (e.g., processor 1620), such as via the bus 1610. Communicative coupling between a processor 1620 and a memory 1630 may enable the processor 1620 to read and/or process information stored in the memory 1630 and/or to store information in the memory 1630.

The input component 1640 may enable the device 1600 to receive input, such as user input and/or sensed input. For example, the input component 1640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 1650 may enable the device 1600 to provide output, such as via a display, a speaker, and/or a light-emitting diode. The communication component 1660 may enable the device 1600 to communicate with other devices via a wired connection and/or a wireless connection. For example, the communication component 1660 may include a receiver, a transmitter, a transceiver, a modem, a network interface card, and/or an antenna.

The device 1600 may perform one or more operations or processes described herein. For example, a non-transitory computer-readable medium (e.g., memory 1630) may store a set of instructions (e.g., one or more instructions or code) for execution by the processor 1620. The processor 1620 may execute the set of instructions to perform one or more operations or processes described herein. In some implementations, execution of the set of instructions, by one or more processors 1620, causes the one or more processors 1620 and/or the device 1600 to perform one or more operations or processes described herein. In some implementations, hardwired circuitry may be used instead of or in combination with the instructions to perform one or more operations or processes described herein. Additionally, or alternatively, the processor 1620 may be configured to perform one or more operations or processes described herein. Thus, implementations described herein are not limited to any specific combination of hardware circuitry and software.

The number and arrangement of components shown in FIG. 16 are provided as an example. The device 1600 may include additional components, fewer components, different components, or differently arranged components than those shown in FIG. 16. Additionally, or alternatively, a set of components (e.g., one or more components) of the device 1600 may perform one or more functions described as being performed by another set of components of the device 1600.

The following provides an overview of some Aspects of the present disclosure:

Aspect 1: A method of wireless communication performed by a distributed node, comprising: transmitting, in association with a service server, a path switch request message indicating to configure a path between the service server and the distributed node; receiving an acknowledgement of the path switch request message; and communicating with the service server on the path.

Aspect 2: The method of Aspect 1, wherein the service server comprises a data routing service for user data.

Aspect 3: The method of any of Aspects 1-2, wherein the service server is associated with data or control signaling for a service.

Aspect 4: The method of any of Aspects 1-3, wherein transmitting the path switch request message further comprises transmitting the path switch request message during a completion phase of a handover in which the distributed node is a target distributed node.

Aspect 5: The method of any of Aspects 1-4, wherein the path switch request message includes at least one of: a distributed node address for a data session, a distributed node address for a service, information indicating a rejected data session, or information indicating a rejected service.

Aspect 6: The method of any of Aspects 1-5, wherein the acknowledgement indicates a service server address of the service server.

Aspect 7: The method of any of Aspects 1-6, wherein transmitting the path switch request message further comprises transmitting the path switch request message to the service server.

Aspect 8: The method of any of Aspects 1-7, wherein transmitting the path switch request message further comprises transmitting the path switch request message to a mobility service.

Aspect 9: The method of any of Aspects 1-8, further comprising receiving, from the service server, buffered data associated with a handover in which the distributed node is a target distributed node.

Aspect 10: A method of wireless communication performed by a service server, comprising: receiving, in association with a distributed node, a path switch request message indicating to configure a path between the service server and the distributed node; transmitting an acknowledgement of the path switch request message; and configuring the path to the distributed node.

Aspect 11: The method of Aspect 10, wherein the service server comprises a data routing service for user data.

Aspect 12: The method of any of Aspects 10-11, wherein the service server is associated with data or control signaling for a service.

Aspect 13: The method of any of Aspects 10-12, wherein receiving the path switch request message further comprises receiving the path switch request message during a completion phase of a handover in which the distributed node is a target distributed node.

Aspect 14: The method of any of Aspects 10-13, wherein the path switch request message includes at least one of: a distributed node address for a data session, a distributed node address for a service, information indicating a rejected data session, or information indicating a rejected service.

Aspect 15: The method of any of Aspects 10-14, wherein the acknowledgement indicates a service server address of the service server.

Aspect 16: The method of any of Aspects 10-15, wherein receiving the path switch request message further comprises receiving the path switch request message from the distributed node.

Aspect 17: The method of any of Aspects 10-16, wherein receiving the path switch request message further comprises receiving the path switch request message from a mobility service.

Aspect 18: The method of any of Aspects 10-17, further comprising transmitting, to the distributed node, buffered data associated with a handover in which the distributed node is a target distributed node.

Aspect 19: The method of Aspect 18, further comprising: receiving, from a source distributed node of the handover and prior to transmitting the buffered data, a handover indication; and buffering the buffered data in association with the handover indication.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIGS. 2 and 16. Reference to “one or more memories” should be understood to refer to any one or more memories of a corresponding device, such as the memory described in connection with FIGS. 2 and 16. For example, functions described as being performed by one or more memories can be performed by the same subset of the one or more memories or different subsets of the one or more memories.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A distributed node for wireless communication, comprising:
one or more memories; and
one or more processors, coupled to the one or more memories, individually or collectively configured to:
transmit, in association with a service server, a path switch request message indicating to configure a path between the service server and the distributed node;
receive an acknowledgement of the path switch request message; and
communicate with the service server on the path.

2. The distributed node of claim 1, wherein the service server comprises a data routing service for user data.

3. The distributed node of claim 1, wherein the service server is associated with data or control signaling for a service.

4. The distributed node of claim 1, wherein the one or more processors, to transmit the path switch request message, are individually or collectively configured to transmit the path switch request message during a completion phase of a handover in which the distributed node is a target distributed node.

5. The distributed node of claim 1, wherein the path switch request message includes at least one of:
a distributed node address for a data session,
a distributed node address for a service,
information indicating a rejected data session, or
information indicating a rejected service.

6. The distributed node of claim 1, wherein the acknowledgement indicates a service server address of the service server.

7. The distributed node of claim 1, wherein the one or more processors, to transmit the path switch request message, are individually or collectively configured to transmit the path switch request message to the service server.

8. The distributed node of claim 1, wherein the one or more processors, to transmit the path switch request message, are individually or collectively configured to transmit the path switch request message to a mobility service.

9. The distributed node of claim 1, wherein the one or more processors are further individually or collectively configured to receive, from the service server, buffered data associated with a handover in which the distributed node is a target distributed node.

10. A service server for wireless communication, comprising:
one or more memories; and
one or more processors, coupled to the one or more memories, individually or collectively configured to:
receive, in association with a distributed node, a path switch request message indicating to configure a path between the service server and the distributed node;
transmit an acknowledgement of the path switch request message; and
configure the path to the distributed node.

11. The service server of claim 10, wherein the service server comprises a data routing service for user data.

12. The service server of claim 10, wherein the service server is associated with data or control signaling for a service.

13. The service server of claim 10, wherein the one or more processors, to receive the path switch request message, are individually or collectively configured to receive the path switch request message during a completion phase of a handover in which the distributed node is a target distributed node.

14. The service server of claim 10, wherein the path switch request message includes at least one of:
a distributed node address for a data session,
a distributed node address for a service,
information indicating a rejected data session, or
information indicating a rejected service.

15. The service server of claim 10, wherein the acknowledgement indicates a service server address of the service server.

16. The service server of claim 10, wherein the one or more processors, to receive the path switch request message, are individually or collectively configured to receive the path switch request message from the distributed node.

17. The service server of claim 10, wherein the one or more processors, to receive the path switch request message, are individually or collectively configured to receive the path switch request message from a mobility service.

18. The service server of claim 10, wherein the one or more processors are further individually or collectively configured to transmit, to the distributed node, buffered data associated with a handover in which the distributed node is a target distributed node.

19. The service server of claim 18, wherein the one or more processors are individually or collectively configured to:
receive, from a source distributed node of the handover and prior to transmitting the buffered data, a handover indication; and
buffer the buffered data in association with the handover indication.

20. A method of wireless communication performed by a distributed node, comprising:
transmitting, in association with a service server, a path switch request message indicating to configure a path between the service server and the distributed node;
receiving an acknowledgement of the path switch request message; and
communicating with the service server on the path.

21. The method of claim 20, wherein the service server comprises a data routing service for user data.

22. The method of claim 20, wherein the service server is associated with data or control signaling for a service.

23. The method of claim 20, wherein transmitting the path switch request message further comprises transmitting the path switch request message during a completion phase of a handover in which the distributed node is a target distributed node.

24. The method of claim 20, wherein the path switch request message includes at least one of:
a distributed node address for a data session,
a distributed node address for a service,
information indicating a rejected data session, or
information indicating a rejected service.

25. The method of claim 20, wherein the acknowledgement indicates a service server address of the service server.

26. The method of claim 20, wherein transmitting the path switch request message further comprises transmitting the path switch request message to the service server.

27. The method of claim 20, wherein transmitting the path switch request message further comprises transmitting the path switch request message to a mobility service.

28. The method of claim 20, further comprising receiving, from the service server, buffered data associated with a handover in which the distributed node is a target distributed node.

29. A method of wireless communication performed by a service server, comprising:
receiving, in association with a distributed node, a path switch request message indicating to configure a path between the service server and the distributed node;
transmitting an acknowledgement of the path switch request message; and
configuring the path to the distributed node.

30. The method of claim 29, further comprising:
receiving, from a source distributed node, a handover indication associated with a handover in which the distributed node is a target distributed node;
buffering data in association with the handover indication; and
transmitting, to the service server, the buffered data.
